(19) United States
(12) Patent Application Publication
(10) Pub. No.: US 2006/0239807 A1
(43) Pub. Date: Oct. 26, 2006

(54) Transporter for ride-on power trowel

(76) Inventor: Scott A. Richer SR., Sanford, ME (US)

Correspondence Address: BOHAN, MATHERS & ASSOCIATES, LLC, PO BOX 17707, PORTLAND, ME, 04112-8707, US

(21) Appl. No.: 11/114,586

(22) Filed: Apr. 26, 2005

(51) Int. Cl. B60P 1/00

(52) U.S. Cl. 414/540

(57) ABSTRACT

A transporter for lifting and transporting a ride-on trowel. The transporter is equipped with vehicle drive means for maneuvering along a ground surface and a hydraulic lift system for raising and lowering a lifting means, which may be hooks and cables that attach to eye bolts or lifting studs that insert into lifting points on the ride-on trowel. The ride-on trowel is raised above ground by the hydraulic lift system and then transported within the frame of the transporter to a new location.

### BACKGROUND INFORMATION

1. Field of the Invention

The invention relates to the field of transporters. More particularly, the invention relates to a transporter for industrial ride-on power trowels used for surface treatment of concrete floors.

2. Description of the Prior Art

Many large facilities, such as buildings for expositions or trade-shows, “big-box” retail stores, warehouses, etc. have concrete floors. After the concrete has been poured and set, the floor is troweled to achieve a smooth surface. The trowel was initially a powered trowel that the operator walked beside as it moved across the concrete surface, similar to the operation of a lawnmower. The size of the pours has increased greatly in recent years and ride-on trowels have been developed to make it easier to trowel such large areas. These ride-on trowels are large, extremely heavy power machines. Not only does the trowel have very heavy gear for grinding the concrete surface to a smooth finish, but it also is equipped with the drive means and a seat for the operator, who rides on the trowel and guides it across the floor. One example of such ride-on trowels is the HYDROSTATIC STX-55J-6 by Whiteman, which has a footprint of 125×65 inches, is 57 inches high, and weighs 2,270 lbs. Even the smallest of the ride-on power trowels has a footprint of 71×39 inches and weighs 440 lbs.

It is very difficult to move these ride-on trowels from one location to another. Lifting units, such as hydraulically, mechanically, or electrically powered hand trucks, are typically used to lift the ride-on trowel above the ground surface. For example, two lifting units are coupled with lifting points provided on the ride-on trowel, are then actuated to lift the ride-on trowel several inches above ground. Once lifted above ground, two to six persons, depending on the size of the ride-on trowel, now push the ride-on trowel along the ground or up or down a loading ramp. The process is time-consuming and potentially very hazardous, as the risks are great of losing control over the ride-on trowel and, as a result, suffering injury to personnel and/or economic loss due to damage to the trowel or other equipment. The task of pushing a ride-on trowel across a soft ground surface, such as sand, with the lifting units is almost impossible. In that case, a powered hoist means must be employed to lift the ride-on trowel above ground.

What is needed therefore is a transportation means for quickly and safely transporting a ride-on trowel. What is further needed is such a means that lifts the ride-on trowel above the ground surface and moves it to another location.

### BRIEF SUMMARY OF THE INVENTION

The problem of maneuvering and transporting the ride-on trowel is solved by providing a trowel transporter that lifts and transports the ride-on trowel, safely, and without danger of injuring personnel or damaging the ride-on trowel itself. The trowel transporter is a wheeled vehicle comprising a hydraulic lift system for lifting and lowering the ride-on trowel, a frame for securing the ride-on trowel above ground, and drive means for moving the trowel transporter across a ground surface.

The frame is a rugged steel vehicle frame that forms a receiving bay for receiving the ride-on trowel. A drive system with wheels and a brake provides the trowel transporter with mobility and maneuverability. The hydraulic lift system and the drive system are powered by a hydraulic power plant that includes conventional hydraulic components, such as a fluid reservoir, hydraulic fluid lines, valves and controls, a hydraulic pump unit, and an engine for driving the pump unit.

The hydraulic lift system includes a hydraulic piston-and-cylinder unit that is assembled on the frame. Attachment means are provided on the frame for coupling the frame with lifting points on the ride-on trowel. The attachment means may include lifting pins or studs mounted on a movable or slidable bracket. The lifting studs are insertable into lifting points that are bores provided on the lower portion of the ride-on trowel. Once attached, the ride-on trowel is lifted above the ground surface by the piston-and-cylinder unit. This is done, for example, by hydraulically lifting the bracket or portion of the frame to which the lifting studs are attached. It is also possible to provide hooks and cables as an attachment means. The cables are suspended from an upper portion of the frame. The hooks are attachable to lifting points that are eye bolts provided on readily accessible areas of the ride-on trowel. The hook ends of the cables are lifted or lowered by the hydraulic lift system.

To move a ride-on trowel, the trowel transporter is driven into an operating position, in which the ride-on trowel is received into the receiving bay. The attachment means are attached to the lifting points on the ride-on trowel. It may be desirable to provide buffers or other securing means between the ride-on trowel and the frame to prevent damage to the ride-on trowel or the trowel transporter during transportation. Once lifted and secured within the trowel transporter, the trowel transporter with ride-on trowel may be driven to a new location or over a loading ramp of a flatbed trailer.

The scope of the invention includes various configurations of the drive system. Often, the trowel transporter will be used to transport the ride-on trowel a short distance, from one area of a construction site to another, or onto or off of a loading ramp. For such purposes, a three-wheeled drive system provides the necessary stability and mobility, and is economical. A drive wheel is provided at a first end of the frame and two follower wheels at a second end of the frame. The drive wheel is provided with steering linkage and a brake. It is, of course, within the scope of the invention to provide a four-wheeled trowel transporter. It is also within the scope of the invention to provide various ways of providing operator control of the trowel transporter. For example, in a simple configuration, a steering bar with a brake control is linked to the drive wheel. To operate the trowel transporter, the operator starts the drive motor, grasps the steering bar and walks alongside the trowel transporter, steering the drive wheel by moving the steering bar to the right or left. It is, however, within the scope of the invention to incorporate an operator seat and control panel within the vehicle frame, to enable the operator to be seated while driving the trowel transporter.

### BRIEF DESCRIPTION OF THE DRAWINGS

The present invention is described with reference to the accompanying drawings. In the drawings, like reference numbers indicate identical or functionally similar elements. The drawings are not to scale.

FIG. 1 is a perspective view of the trowel transporter according to the invention, showing the ride-on trowel lifted above ground with a first embodiment of the lifting means, and secured within the frame of the trowel transporter.

FIG. 2 is an elevational view of the open end of the trowel transporter of FIG. 1.

FIG. 3 is a plane view of the top of the vehicle frame, showing the hydraulic lifting means.

FIG. 4 is side view of the hydraulic lifting means.

FIG. 5A is an illustration of a second embodiment of the lifting means, showing a lifting bracket and a piston-and-cylinder unit to slidably shifting the lifting bracket upward.

FIG. 5B is a side view of the lifting means of FIG. 5A, showing the lifting stud bar for insertion into a lifting point on a ride-on trowel.

FIG. 6 is a schematic illustration of the trowel transporter according to the invention.

### DETAILED DESCRIPTION OF THE INVENTION

The present invention will now be described more fully in detail with reference to the accompanying drawings, in which preferred embodiments of the invention are shown. This invention should not, however, be construed as limited to the embodiments set forth herein; rather, they are provided so that this disclosure will be complete and will fully convey the scope of the invention to those skilled in the art.

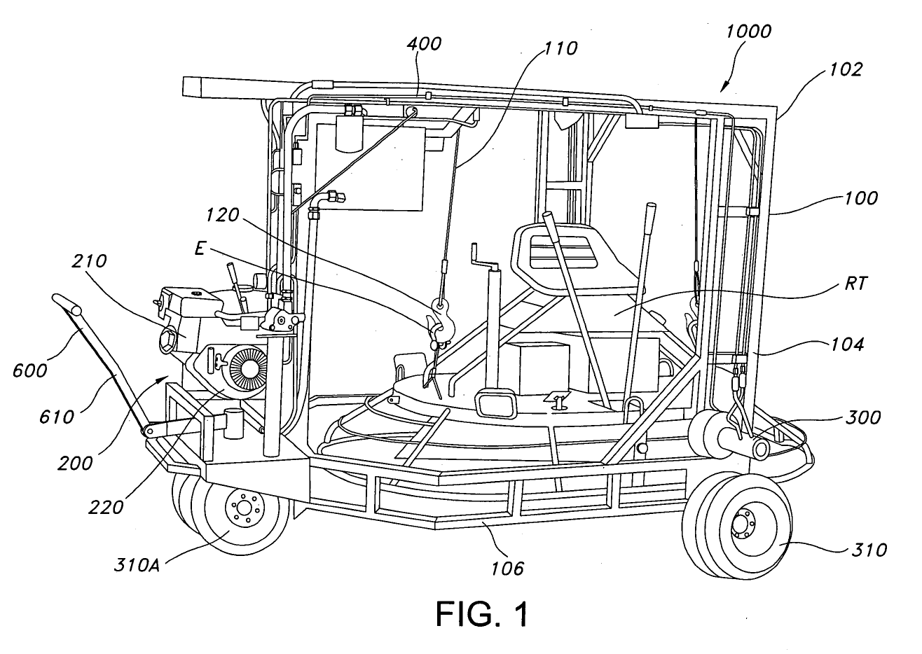

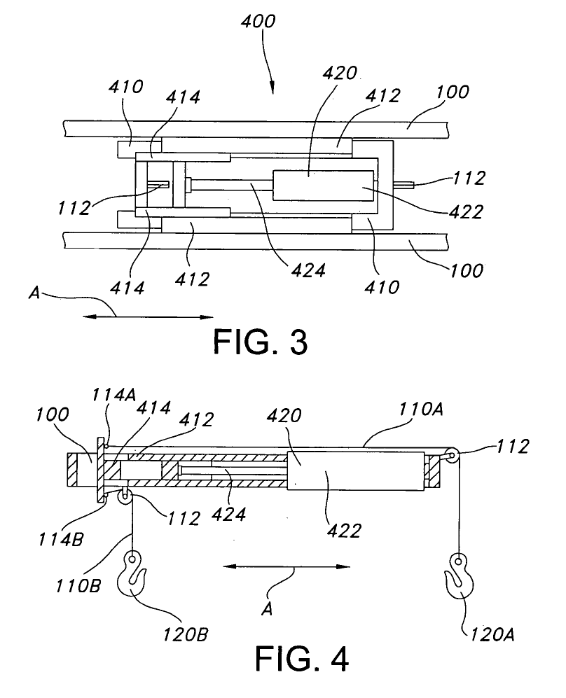

FIG. 1 is a perspective view of the trowel transporter 1000 according to the invention for transporting a ride-on trowel RT. The trowel transporter 1000 has a vehicle frame 100 with a receiving bay 109, a power plant 200, a hydraulic lift system 400 (shown with greater detail in FIGS. 3 and 4), wheel drive means 300, and a steering unit 600. As shown here, the ride-on trowel RT is supported in the bay 109 on lifting means 110 and attachment means 120 that depend from the vehicle frame 100. The ride-on trowel RT is a commercially available machine that comes in various sizes. The power plant 200 includes a hydraulic system 230 with a reservoir of hydraulic fluid, valves, and controls, a hydraulic pump 220, and an engine 210 that powers the hydraulic pump 220. The hydraulic lift system 400 includes a piston-and-cylinder unit 420 that is mounted in the vehicle frame 100 and is actuated by the hydraulic pump 220 to raise and lower the lifting means 110. The wheel drive means 300 includes a drive motor 320 and wheels 310, at least one of which is a drive wheel 310A. Each drive wheel 310A, if there is more than one, is driven by its own drive motor 320. In the preferred embodiment of the trowel transporter 1000, the drive motor 320 drives a chain and sprocket mechanism 330, which, in turn, drives the drive wheel 310A. A hydraulic brake 340 is provided on at least one drive wheel 310A. The steering unit 600 for steering the trowel transporter 1000 is provided at one end of the frame 100 and includes a steering bar 610 with steering linkage linked to one of the drive wheels 310A.

The engine 210, the hydraulic pump 220, the drive motor 320, the chain-and-sprocket mechanism 330, the steering unit 600, and the brake 340 are conventional assemblies, well-known in the art, and are not described in greater detail herein. The following examples of suitable assemblies are provided for illustration purposes only and it is understood that the scope of the invention is not limited to any particular make, model or size of these assemblies. The drive motor 320 is a hydraulic general purpose Char-Lynn® Orbit® motor from the Eaton Corp. In this embodiment, the engine 210 is a GX 240-390 series gasoline engine from the Honda Motor Co., Ltd. The pump 220 is a hydraulic GC Series pump from Haldex, rated at 8 GPM at 3600 RPM. The chain-and-sprocket mechanism 330 is available from any automotive parts store, and the brake 340 is a hydraulic MICO disc brake. The drive motor 320 and the brake 340 is provided by the hydraulic power means 200.

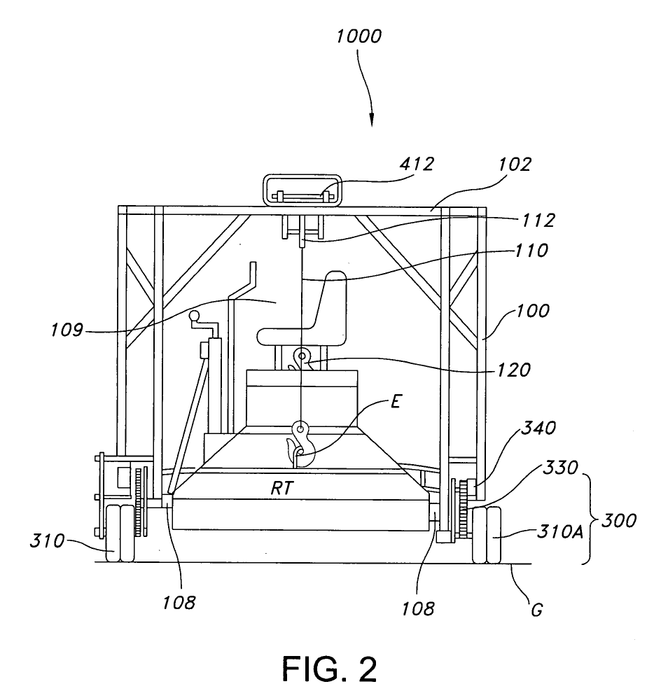

FIG. 2 is an elevational view of the trowel transporter 1000, showing the ride-on trowel RT captured within the trowel transporter 1000. The vehicle frame 100 comprises an upper frame 102, a lower frame 106, and vertical supports 104. As seen in FIG. 2, the lower frame 106 does not extend across the rear end of the vehicle frame 100, leaving the receiving bay 109 open for receiving the ride-on trowel RT. The trowel transporter 1000 is thus maneuverable into an operational position, in which the upper frame 102 is positioned above the ride-on trowel RT and the lower frame 106 surrounds it on three sides. Securing means 108 are attached to the ride-on trowel RT to keep it from swinging and hitting the trowel transporter 1000 during transportatation. The securing means 108 may be tug straps or buffer members or other suitable securing devices that will prevent the ride-on trowel RT from swinging and hitting the trowel transporter.

FIGS. 3 and 4 illustrate a first embodiment of the lifting means 110 and the piston-and-cylinder unit 420. In this embodiment, the lifting means 110 is a cable with a hook as an attachment means 120. The piston-and-cylinder unit 420 is mounted in an auxiliary frame 410, which-is attached to the vehicle frame 100. In the embodiment shown, a bracket or track 412 is fixedly and rigidly attached to the vehicle frame 100 and the auxiliary frame 410 mounted therein. A first piston end 424A is fixedly attached to a sliding bracket 414 that slides along the track 412. A second piston end 424B is captured within the cylinder 422. A first end of the lifting means 110 is securely attached to the sliding bracket 414 at point 114. In the embodiment shown, the lifting means 110 includes at least two cables 110A, 110B that are attached at points 114A and 114B, respectively. The piston 424 moves into or out of the cylinder 422 when the hydraulic lift system 400 is actuated. This causes the sliding bracket 414 to translate along the track 412 as indicated by arrow A. As the sliding bracket 414 is pulled in toward the cylinder 422, the lifting means 110A and 110B are lowered or raised, depending on the direction of travel of the sliding bracket 414. A guide 112, such as a pulley wheel, may be provided to guide the lifting means 110 from a horizontal to a vertical orientation downward toward the bay. The power means 200 for driving the piston-and-cylinder unit 420 are mounted elsewhere on the vehicle frame 100. The power means 200 includes the first engine 210 for driving the hydraulic pump 220. It is well-known in the field how to connect hydraulic power means to a piston-and-cylinder unit and these connections are not shown in detail herein.

The conventional ride-on trowel RT is typically provided with attachment points, such as eye bolts E or other suitable means for attaching two cables 110A and 110B with their corresponding attachment means 120A and 120B, as shown in FIGS. 1 and 2. If such attachment means are not provided, they can easily be added to the ride-on trowel RT.

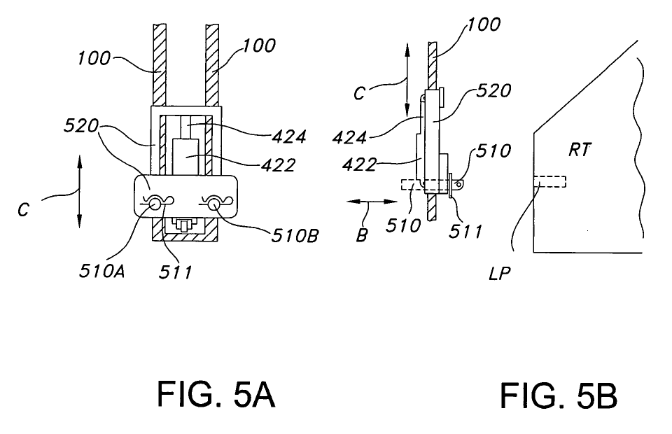

FIGS. 5A and 5B illustrate a second embodiment of lifting means 510 of the trowel transporter 1000 according to the invention. The lifting means 510 includes two lifting studs 510A, 510B that are movably assembled in a lifting bracket 520. The lifting studs 510A, 510B are insertable into lifting points LP typically provided on the chassis of the ride-on trowel RT. In the embodiment shown, the lifting studs 510A, 510B are manually moved from a retracted position to a lifting position, as indicated by arrow B. The lifting bracket 520 is slidably mounted on the frame 100. The piston-and-cylinder unit 420 is also mounted on the frame 100, with the operating end 424A of the piston attached to the lifting bracket 520. The trowel transporter 1000 is maneuvered into position around the ride-on trowel RT and the lifting studs 510A, 510B inserted into the lifting points LP on the ride-on trowel. In the embodiment shown, cotter pins are used to secure the lifting studs 510A, 510B and the ride-on trowel RT in position. Once the ride-on trowel RT is securely seated on the lifting studs 510A, 510B, the piston-and-cylinder unit 420 is actuated and the lifting bracket 520 moved upward, as indicated by arrow C, lifting the ride-on trowel above the ground surface.

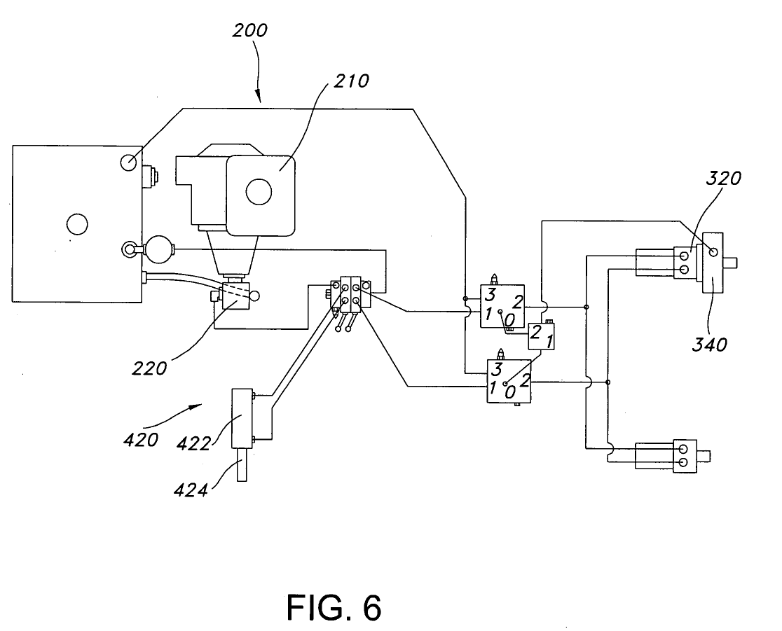

FIG. 6 is a schematic diagram of the systems that power the trowel transporter 1000. As shown, the hydraulic power means 200 operates the piston-and-cylinder unit 420, the drive motors 320, and the brake 320. The schematic shows two drive motors 320 and one brake 340. This is for purposes of illustration only and in now way limits the invention to the use of two driven wheels and one brake.

It is understood that the embodiments described herein are merely illustrative of the present invention. Variations in the construction of the trowel transporter may be contemplated by one skilled in the art without limiting the intended scope of the invention herein disclosed and as defined by the following claims.

What is claimed is:

1: A vehicle for transporting a ride-on trowel, said vehicle comprising:
a vehicle frame with vehicle drive means, said vehicle frame forming a bay for receiving said ride-on trowel;
attachment means for attaching said ride-on trowel to said vehicle frame;
lifting means attached to said vehicle frame for attaching to said ride-on trowel; and
a hydraulic lift system that operates said lifting means.

2: The vehicle of claim 1, wherein said vehicle frame has an upper frame and a lower frame, said lower frame being mounted on wheels and said upper frame connected to said lower frame, wherein said lower frame has three sides that form said bay, and wherein said upper frame extends across said bay.

3: The vehicle of claim 2, wherein said hydraulic lift system includes a piston-and-cylinder unit mounted on said upper frame and a sliding bracket slidably mounted on said upper frame, wherein a piston has an operating piston end that is affixed to said sliding bracket and a fixed piston end that is fixedly attached to a cylinder, and wherein said lifting means is attached to said sliding bracket.

4: The vehicle of claim 3, wherein said hydraulic lift system further includes a guide means for guiding said lifting means downward toward said bay.

5: The vehicle of claim 1 further comprising a power source for powering said hydraulic lift system, said power source including a fluid reservoir, hydraulic fluid lines and hydraulic control valves, a pump drive means, and a hydraulic pump, wherein said pump drive means powers said hydraulic pump and said pump drives said piston-and-cylinder unit.

6: The vehicle of claim 5, wherein said pump drive means is a combustion engine.

7: The vehicle of claim 1, wherein said vehicle drive means includes wheels and a wheel drive means.

8: The vehicle of claim 7 further comprising a brake means that is coupled to at least one of said wheels.

9: The vehicle of claim 8, wherein said brake means is a hydraulic brake power by said power source.

10: The vehicle of claim 7, wherein said vehicle drive means further includes a chain-and-sprocket assembly coupled to at least one of said wheels, and a motor to drive said wheel and sprocket.

11: The vehicle of claim 9, wherein said motor is a hydraulic motor powered by said power source.

12: The vehicle of claim 1, wherein said lifting means is a cable with a lifting hook attached to an operating end.

13: The vehicle of claim 1, wherein said lifting means includes a lifting stud that is insertable into a lifting point on said ride-on trowel.

14: The vehicle of claim 13, wherein said lifting means further includes a lifting bracket slidably mounted on said frame, wherein said lifting stud is fixedly attached to said lifting bracket, and wherein an operating end of said piston-and-cylinder unit is attached to said lifting bracket, so as to move said lifting bracket such that said lifting stud is raised or lowered.

15: The vehicle of claim 14, wherein said piston-and-cylinder unit is mounted on said vehicle frame.
